(19) United States
(12) Patent Application Publication
(10) Pub. No.: US 2002/0095743 A1
(43) Pub. Date: Jul. 25, 2002

(54) Handle assembly for a hose and coupling device and a method of assembling the same

(75) Inventors: Daniel Henry Schneider, Franklin, WI (US); Leo Todd Spychalla, Watertown, WI (US)

Correspondence Address: MICHAEL BEST & FRIEDRICH, LLP, 100 E WISCONSIN AVENUE, MILWAUKEE, WI, 53202, US

(73) Assignee: Velvac, Inc., New Berlin, WI

(21) Appl. No.: 09/862,713

(22) Filed: May 22, 2001

Related U.S. Application Data
(60) Provisional application No. 60/262,743, filed on Jan. 19, 2001.

(51) Int. Cl. E05B 1/00

(52) U.S. Cl. 16/111.1

(57) ABSTRACT

A two-piece interlocking handle assembly which provides a rigid hand hold for a hose and coupling device received thereby, the handle assembly being particularly useful when coupling a glad hand operatively mounted to the hose and coupling device extending from a trailer of a semi-tractor to a glad hand operatively mounted to a mating air brake line extending from the semi-tractor. The handle assembly includes two opposing halves which are releasably connectable by slidably engaging projecting members of one half with associated slots of the other half. Resilient locking members mounted on one half engage the other half to securely connect the halves together.

### FIELD OF THE INVENTION

The invention relates to a handle for a hose and coupling device. More particularly, the invention relates to a handle for a hose and coupling device of a service or emergency air brake line extending from a semi-tractor or trailer.

### BACKGROUND OF THE INVENTION

Glad hands are known devices which connect service and emergency air brake lines of a semi-tractor to associated service and emergency air brake lines of a trailer. As generally known, to connect a glad hand operatively attached to an air hose extending from a semi-tractor to a glad hand operatively attached to an air hose extending from a trailer, the glad hands are first usually positioned at about a 90-degree angle relative to each other and rubber seals associated with each glad hand are pressed together. Thereafter, at least one of the glad hands is turned or rotated with respect to the other, so as to securely join and lock the glad hands together. A problem with this type of arrangement is that one or both of the air hoses may be used as a lever when coupling the glad hands together, thereby potentially causing premature failure of the associated air line hose.

### SUMMARY OF THE INVENTION

The present invention solves the above-mentioned problem and other problems of the prior art by providing a handle assembly so that an air line hose itself does not have to be used as a lever when coupling glad hands together. The handle assembly of the present invention is a two-piece interlocking device which includes releasably connectable complimentary halves for accepting the outer diameter of a hose and at least a portion of a coupling device which is threadably secured to a hose fitting attached to a free end of the hose and which is also threadably secured to a glad hand. In one embodiment, the halves are connected together by slidably engaging at least one male member of one half with at least one mating female member of the other half. In a preferred embodiment, a resilient locking member releasably secures the halves together.

Accordingly, the handle assembly of the present invention is easy to assemble and disassemble, is cost effective to manufacture and, at the same time, is of durable construction for effective operation.

Another feature of the present invention is that the handle assembly can be easily removed and re-used on other hoses by simply unlocking and separating the halves.

Yet another feature of the present invention is that the halves of the handle assembly are connectable without having to use independent fasteners, such as screws, which require the use of an additional tool, such as a screw driver. In the same vein, the halves of the handle assembly can be disconnected by hand, thereby eliminating the need for a separate mechanical disconnecting device.

Other features and advantages of the invention will become apparent to those skilled in the art upon review of the following detailed description, claims, and drawings, in which like numerals are used to designate like features.

### BRIEF DESCRIPTION OF THE DRAWINGS

FIG. 1 is a perspective view illustrating a handle assembly according to the present invention, wherein the handle assembly is secured to an air line hose and coupling device which is attached to a glad hand.

FIG. 2 is an exploded perspective view of the handle assembly of FIG. 1.

FIG. 3 is an exploded plan view illustrating the relationship of the inner surfaces of the handle assembly and the outer surfaces of the air line hose and coupling device of FIG. 1.

FIG. 4 is an exploded side elevational view of the handle assembly and the air line hose and coupling device of FIG. 3.

FIG. 5 is a side elevational view illustrating the assembly of the handle assembly of FIG. 4 around the hose and coupling device of FIG. 4.

FIG. 6 is a cross-sectional view taken along line VI-VI of FIG. 5.

FIG. 7 is an end view of one half of the handle assembly shown in FIG. 3.

FIG. 8 is an end view of the other half of the handle assembly shown in FIG. 3.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting.

### DESCRIPTION OF THE PREFERRED EMBODIMENT

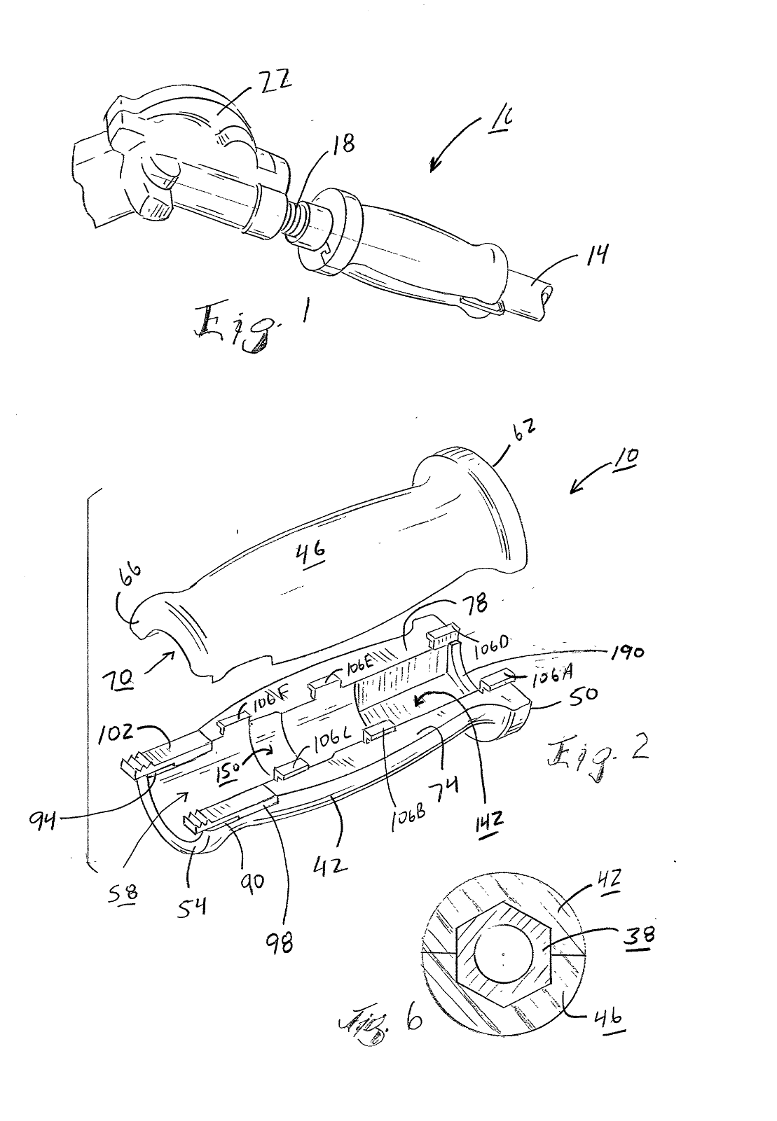

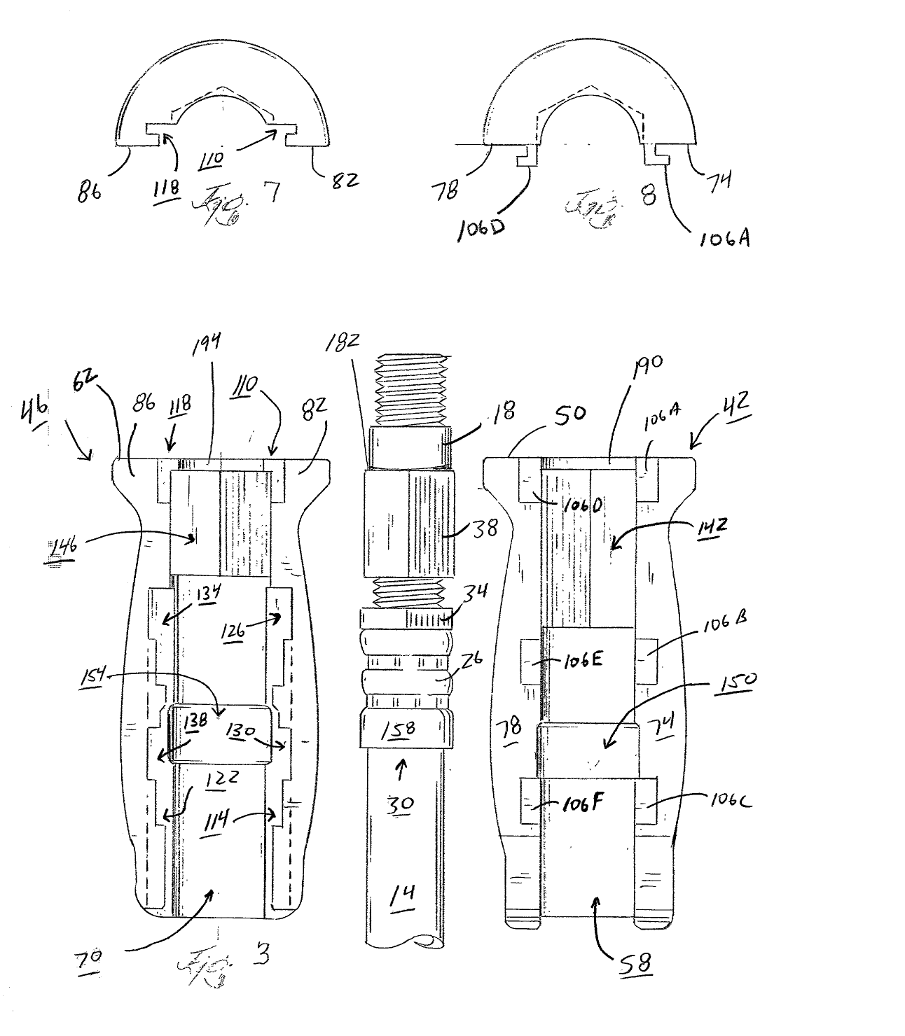

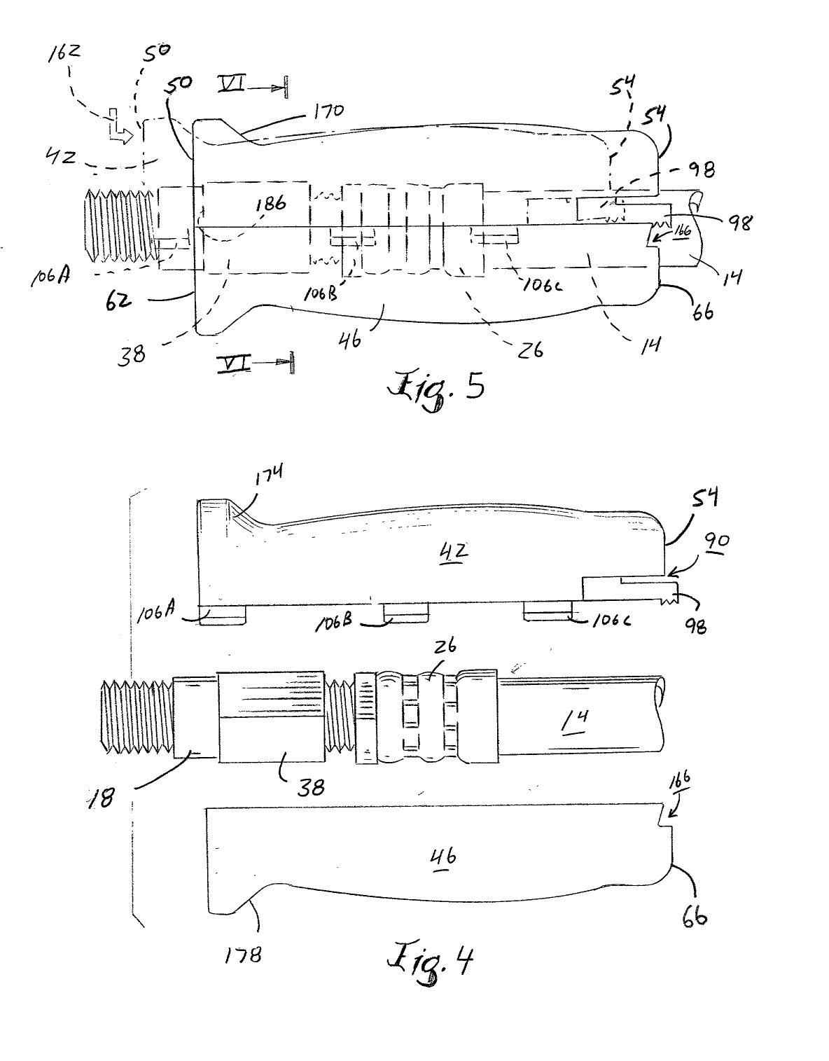

Illustrated in FIG. 1 is a handle assembly 10 secured to a conventional air brake line 14 and coupling device 18 which in turn is secured to a conventional glad hand 22, all of which are part of a semi-tractor/trailer air brake line assembly. With reference to FIG. 3, a hose fitting 26 is secured to the free end 30 of the hose 14, and the coupling device 18 is threadably attached to the hose fitting 26. The hose fitting 26 includes a nut 34 and the coupling device 18 includes a nut 38, so that the coupling device 18 can be threadably and securely fastened to the hose fitting 26. The handle assembly 10 provides a hand hold lever when connecting conventional glad hands of a semi-tractor/trailer combination. It should be understood that although the handle assembly 10 is shown and described in association with the hose 14 and coupling device 18 of a semi-tractor/trailer air brake line assembly, the handle assemble 10 is capable of use with other hose assemblies and/or hose and coupling device assemblies, and the hose 14 and coupling device 18 are merely shown and described as an example of one such assembly.

Unless otherwise specified, reference is made to FIG. 2 in regards to the structural description of the handle assembly 10. The handle assembly 10 is preferably made of an injected molded polypropylene plastic, but may be made of other suitable materials according to the principles of the present invention. The handle assembly 10 includes a first handle portion or half 42 and a second handle portion or half 46. The first handle portion 42 includes a forward end 50 and a rearward end 54, with a semicylindrical bore 58 extending therebetween, and the second handle portion 46 includes a forward end 62 and a rearward end 66, with a semicylindrical bore 70 extending therebetween. The semicylindrical bores 58 and 70 cooperate to accept a portion of the hose 14 and coupling device 18 when the first and second handle portions 42 and 46 are interconnected together.

The first handle portion 42 also includes substantially flat engagement surfaces 74 and 78 (see also FIG. 3) extending along opposite sides of the semicylindrical bore 58, and the second handle portion 46 also includes substantially flat engagement surfaces 82 and 86 (FIG. 3) extending along opposite sides of the semicylindrical bore 70. The engagement surfaces 74 and 78 respectively include recesses 90 (see also FIG. 4) and 94 extending from the rearward end 54. Resilient locking members 98 and 102 are respectively positioned within recesses 90 and 94. Preferably, the resilient locking members 98 and 102 are formed or molded as a part of the handle portion 42. Alternatively, the resilient locking members 98 and 102 can be secured within recesses 90 and 94 by any suitable means, such as by using an appropriate industrial strength adhesive. The resilient locking members 98 and 102 are used to securely connect the first handle portion 42 to the second handle portion 46.

The first handle portion 42 further includes a plurality of L-shaped tab members 106A-F (see also, e.g., FIG. 8) projecting from the engagement surfaces 74 and 78. The engagement surface 82 of the second handle portion 46 includes undercut slot 110 (FIGS. 3 and 7) and undercut slot 114 (FIG. 3) for receiving the associated tab members 106D-F, and the engagement surface 86 of the second handle portion 46 includes undercut slot 118 (FIGS. 3 and 7) and undercut slot 122 (FIG. 3) for receiving the associated tab members 106A-C. The undercut slot 114 includes notches 126 and 130 (FIG. 3) for respectively receiving tab members 106E-F and the undercut slot 122 includes notches 134 and 138 (FIG. 3) for respectively receiving tab members 106B-C when the handle portion 42 first comes into contact with the handle portion 46.

The semicylindrical bore 58 of the first handle portion 42 includes a recess 142 (see also FIG. 3) adapted to receive a portion of the coupling device 18, and the semicylindrical bore 70 of the second handle portion 46 includes a recess 146 (FIG. 3) adapted to receive an opposite portion of the coupling device 18. The semicylindrical bores 58 and 70 further include additional opposing recesses 150 (see also FIG. 3) and 154 (FIG. 3), respectively, to receive an enlarged portion 158 (FIG. 3) of the hose fitting 26. As shown in FIG. 3 and as will be further explained below, so that the first handle portion 42 is slidable along the second handle portion 46 when a portion of the coupling device 18 is received by the recesses 142 and 146, recess 142 has a length which is greater than the length of the nut 38 and recess 146 has a length which is substantially equal to the nut 38. Moreover, the recesses 150 and 154 are appropriately sized for receiving the portion 158 of the hose fitting 26 so as not to inhibit the slidable action between the first handle portion 42 and the second handle portion 46.

Having described the structural details of the handle assembly 10, the method of mounting the handle assembly 10 around the hose 14 and coupling device 18 will now be more fully described with particular reference being made to FIGS. 3-5, in conjunction with reference to FIGS. 1 and 2 as needed.

The semicylindrical bore 70 of the second handle portion 46 receives the hose 14 and coupling device 18 such that recess 146 receives one half of nut 38 and recess 154 receives one half of the enlarged portion 158 of the hose fitting 26. The first handle portion 42 is then placed into contact with the second handle portion 46 (see FIG. 5 illustratively showing the first handle portion 42 in phantom), such that the engagement surfaces 74 and 78 are in contact with the associated engagement surfaces 86 and 82, the tab members 106A and 106D are positioned away from the associated slots 118 and 110 beyond the forward end 62 of the second handle portion 46, and the notches 126, 130, 134 and 138 receive the associated tab members 106E, 106F, 106B and 106C.

Thereafter, a force is applied to the first handle portion 42 in the direction of arrow 162 (FIG. 5) until the undercut slots 110, 114, 118 and 122 receive the associated tab members 106A-F to connect the first handle portion 42 to the second handle portion 46 so that the first handle portion 42 cannot be separated from the second handle portion 46 by lifting the first handle portion 42 off of the second handle portion 46, and until the resilient locking members 98 and 102 engage the rearward end 66 of the second handle portion 46 (see FIG. 5 illustrating the first and second handle portions 42 and 46 in solid lines). The oversized recesses 142 and 150 of the first handle portion 42 for the coupling device 18 and fitting 26, respectively, allow the sliding action between the first handle portion 42 and the second handle portion 46 as just described.

As best shown in FIGS. 4 and 5, the rearward end 66 of the second handle portion 46 includes a first cut-out 166 and a second cut-out (not shown) for respectively receiving the resilient locking members 98 and 102. When the handle assembly 10 is completely assembled, the rearward ends 54 and 66 are generally co-planer, the forward ends 50 and 62 are generally co-planar, and an annular shoulder 170 (FIG. 5) is created by the semiannular shoulders 174 and 178 (FIG. 4) of the forward ends 50 and 62, respectively, to create a stop wall to inhibit movement of a person's hand off of the handle assembly 10.

With reference to FIG. 5, the resilient locking members 98 and 102 prevent the first and second handle portions 42 and 46 from being slidably disengaged in one direction, and one end 182 (FIG. 3) of nut 38 abuts an end wall 186 (FIG. 5) defined by wall 190 (FIGS. 2 and 3) of recess 142 and wall 194 (FIG. 3) of recess 146 to prevent the first and second handle portions 42 and 46 from being slidably disengaged in the opposite direction.

To disassemble the handle assembly 10, the portion of each resilient locking member 98 (FIG. 5) and 102 extending beyond the rearward ends 54 and 66 are simply forced out of engagement with the second handle portion 46 and into the respective recesses 90 and 94, so that a force can be applied to the first handle portion 42 in a direction opposite to arrow 162 until the tab members 106A-F are freed from the associated undercut slots 110, 114, 118 and 122, thereby allowing the first handle portion 42 to be disconnected from the second handle portion 46.

Variations and modifications of the foregoing are within the scope of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A handle assembly for a hose and coupling device, said handle assembly comprising:
a first handle portion having a male member; and
a second handle portion having a mating female member for receiving said male member, such that said first handle portion is releasably connectable to said second handle portion around the hose and coupling device.

2. A handle assembly according to claim 1, wherein said male member is an L-shaped tab member and said female member is an undercut slot, and wherein said tab member is slidably positionable within and slidably removable from said undercut slot.

3. A handle assembly according to claim 1, further comprising:
a resilient retaining member movable between a first position and a second position, such that when said first handle portion is connected to said second handle portion and said resilient member is in said first position, said first handle portion and said second handle portion are locked together, and such that when said first handle portion is releasable from said second handle portion, said resilient member is in said second position.

4. A handle assembly according to claim 1, wherein said first handle portion includes a recess for receiving a portion of the coupling device, and wherein the second handle portion includes a recess for receiving an opposite portion of the coupling device.

5. A handle assembly for a hose and coupling device, said handle assembly comprising:
a first handle portion;
a second handle portion; and
a resilient retaining member for releasably securing said first handle portion to said second handle portion around the hose and coupling device.

6. A handle assembly according to claim 5, wherein said resilient retaining member is mounted on said first handle portion, and wherein said resilient retaining member is releasably engagable with said second handle portion.

7. A handle assembly according to claim 5, wherein said first handle portion includes a recess for receiving a portion of the coupling device, and wherein said second handle portion includes a recess for receiving an opposite portion of the coupling device, such that when said first handle portion is secured to said second handle portion, said resilient retaining member prevents said first and second handle portions from being slidably disengaged in one direction, and one end of the coupling device abuts an end wall defined by said recesses in said first and second handle portions to prevent said first and second handle portions from being slidably disengaged in the opposite direction.

8. A handle assembly for a hose and coupling device, said handle assembly comprising:
a first handle portion having a forward end and a rearward end with a generally semicylindrical bore extending therebetween, said semicylindrical bore including a recess adapted to receive a portion of the coupling device, said recess having a length which allows said first handle portion to be moved with respect to the hose and coupling device when said recess receives the portion of the coupling device, said first handle portion also having substantially flat engagement surfaces extending along opposite sides of said bore, each of said engagement surfaces including a recess extending from its respective rearward end, said first handle portion further having a tab member projecting from one of said engagement surfaces and another tab member projecting from the other of said engagement surfaces;
a second handle portion having a forward end and a rearward end with a generally semicylindrical bore extending therebetween, said semicylindrical bore including a recess adapted to receive an opposite portion of the coupling device, said recess having a length which does not allow the second handle portion to be moved with respect to the hose and coupling device when said recess receives this portion of the coupling device, said second handle portion also having substantially flat engagement surfaces extending along opposite sides of said bore, each of said engagement surfaces including an undercut slot; and
a first resilient locking member and a second resilient locking member each being positioned within a respective one of said recesses of said engagement surfaces of said first handle portion, such that to assemble said handle assembly around the hose and coupling device, said recesses of said semicylindrical bores of said first and second handle portions receive the associated portions of the coupling device, and said first handle portion is caused to move with respect to said second handle portion in one direction so that said engagement surfaces of said first handle portion slide along said engagement surfaces of said second handle portion until said undercut slots of said second half portion receive the associated tab members of said first handle portion to connect said first handle portion to said second handle portion and until said resilient locking members engage said rearward end of said second handle portion to securely connect said first handle portion to said second handle portion, and such that to disassemble said handle assembly from the hose and coupling device, said resilient locking members are forced out of engagement with said rearward end of said second handle portion and said first handle portion is caused to move with respect to said second handle portion in the opposite direction so that said engagement surfaces of said first handle portion slide along said engagement surfaces of said second handle portion until said tab members of said first handle portion are freed from the associated undercut slots of said second handle portion to allow said first handle portion to be disconnected from said second handle portion.

9. A handle assembly according to claim 8, wherein said tab members of said first handle portion are L-shaped.

10. A handle assembly according to claim 8, wherein said first handle portion includes at least one other tab member projecting from one of said engagement surfaces and at least one other tab member projecting from the other of said engagement surfaces, and wherein each of said engagement surfaces of said second handle portion include another undercut slot which are adapted to receive and free the associated tab members of said first handle portion.

11. A handle assembly according to claim 8, wherein each of said semicylindrical bores of said first and second handle portions include an additional recess for receiving a respective portion of a hose fitting which is connected to an end of the hose and which receives the coupling device.

12. A handle assembly according to claim 8, wherein said rearward end of said second handle portion includes a first notch and a second notch, such that said first and second resilient locking members are respectively engagable with said first and second notches.

13. A handle assembly according to claim 8, wherein when said first handle portion is securely connected to said second handle portion, said resilient locking members prevent said first and second handle portions from being slidably disengaged in one direction, and wherein one end of the coupling device abuts an end wall defined by each associated recess in said first and second handle portions to prevent said first and second handle portions from being slidably disengaged in the opposite direction.

14. A handle assembly according to claim 8, wherein each of said forward ends of said first and second handle portions includes a semiannular shoulder so as to create an annular shoulder when said first and second handle portions are securely connected, thereby creating a stop wall to inhibit movement of a person's hand off of said handle assembly.

15. A method of assembling a handle assembly around a hose and coupling device, said method comprising the steps of:
providing a first handle portion having a male member;
providing a second handle portion having a female member for receiving said male member of said first handle portion;
placing a portion of the hose and coupling device in one of said first and second handle portions; and
positioning said male member of said first handle portion into said female member of said second handle portion to connect said first and second handle portions together around the hose and coupling device, such that said first and second handle portions cannot disengage absent an intervening force.

16. A method according to claim 15, wherein said male member is an L-shaped tab member and said female member is an undercut slot, and wherein said step of positioning said male member of said first handle portion into said female member of said second handle portion includes sliding said L-shaped tab member into said undercut slot.

17. A method according to claim 15, further comprising the steps of:
providing a resilient retaining member to securely connect said first handle portion to said second handle portion when said male member of said first handle portion is positioned within said female member of said second handle portion, such that said first and second handle portions cannot disengage absent said resilient member being caused to unsecure said first handle portion from said second handle portion.

18. A method of assembling a handle assembly around a hose and coupling device, said method comprising the steps of:
placing a portion of the hose and coupling assembly into a first handle portion of said handle assembly;
positioning a second handle portion opposite said first handle portion; and
connecting said first handle portion to said second handle portion by slidably engaging a projecting member of one of said first and second handle portions with an associated recess of the other of said first and second handle portions.

19. A method according to claim 18, further comprising the step of:
locking said first handle portion to said second handle with a resilient locking member which is mounted on one of said first and second handle portions and which engages the other of said first and second handle portions.
